(19) United States
(12) Patent Application Publication
(10) Pub. No.: US 2019/0340317 A1
(43) Pub. Date: Nov. 7, 2019

(54) COMPUTER VISION THROUGH SIMULATED HARDWARE OPTIMIZATION

(71) Applicant: Microsoft Technology Licensing, LLC, Redmond, WA (US)

(72) Inventors: Jonathan Chi Hang CHAN, Seattle, WA (US); Michael EBSTYNE, Redmond, WA (US); Alex A. KIPMAN, Bellevue, WA (US); Pedro U. ESCOS, Redmond, WA (US); Andrew C. GORIS, Loveland, CO (US)

(21) Appl. No.: 15/973,420

(22) Filed: May 7, 2018

(51) Int. Cl. G06F 17/50

(52) U.S. Cl. CPC G06F 17/5009

(57) ABSTRACT

Systems and methods are disclosed for using a synthetic world interface to model environments, sensors, and platforms, such as for computer vision sensor platform design. Digital models may be passed through a simulation service to generate synthetic experiment data. Systematic sweeps of parameters for various components of the sensor or platform design under test, under multiple environmental conditions, can facilitate time- and cost-efficient engineering efforts by revealing parameter sensitivities and environmental effects for multiple proposed configurations. Searches through the generated synthetic experimental data results can permit rapid identification of desirable design configuration candidates.

### BACKGROUND

Computer vision applications typically require integrating a combination of sensors, processors, and algorithms. Finding a suitable configuration sensor, computation, and algorithm choices may be a challenging and expensive process that involves specialists in multiple disciplines, such as mechanical engineering, electrical engineering, silicon design, computer vision, artificial intelligence (AI), robotics, and data capturing teams. Design teams may attempt to optimize solution design based on power, weight, thermal, and accuracy goals, while simultaneously attempting to support a widest range of environments and scenarios.

Thus, the process for designing a computer vision platform may require the specialists to iterate through employing a series of disparate modeling and development tools along with building prototype devices, testing the prototypes, and then cycling back to update the modeling and development efforts. These efforts would also need to iterate with an algorithm development team, possibly extending the design effort into a duration of months.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Systems and methods are disclosed for using a synthetic world interface to model environments, sensors, and platforms, such as for computer vision sensor platform design. Digital models may be passed through a simulation service to generate synthetic experiment data. Systematic sweeps of parameters for various components of the sensor or platform design under test, under multiple environmental conditions, can facilitate time- and cost-efficient engineering efforts by revealing parameter sensitivities and environmental effects for multiple proposed configurations. Searches through the generated synthetic experimental data results can permit rapid identification of desirable design configuration candidates.

Some aspects and examples disclosed herein are directed to a system for simulating computer vision, the system comprising: a sensor modeler for modeling characteristics of one or more sensors; a device modeler for modeling a device under test, the modeled device under test comprising the modeled characteristics of one or more sensors; an environment and motion modeler for specifying a set of synthetic operating environments and motion profiles for the modeled device under test; a data generator for generating a set of synthetic experiment data, the synthetic experiment data comprising synthetic sensor frames and reference frames based on the modeled device under test and set of synthetic operating environments and motion profiles; a post processor for modeling execution of computer vision algorithms applied to the set of synthetic sensor frames; and an experiment manager for iterating the generation of synthetic experiment data for differing parameters of the modeled device under test or differing synthetic operating environments and motion profiles.

Additional aspects and examples disclosed herein are directed to a method for simulating computer vision, the system comprising: modeling characteristics of one or more sensors; modeling a device under test, the modeled device under test comprising the modeled characteristics of one or more sensors; specifying a set of synthetic operating environments and motion profiles for the modeled device under test; generating a set of synthetic experiment data, the synthetic experiment data comprising synthetic sensor frames and reference frames based on the modeled device under test and set of synthetic operating environments and motion profiles; modeling execution of computer vision algorithms applied to the set of synthetic sensor frames; and iterating the generation of synthetic experiment data for differing parameters of the modeled device under test or differing synthetic operating environments and motion profiles.

Additional aspects and examples disclosed herein are directed to one or more computer storage devices having computer-executable instructions stored thereon for computing a localization parameter, which, on execution by a computer, cause the computer to perform operations, the instructions comprising: a sensor modeling component for modeling characteristics of one or more sensors, wherein the one or more sensors comprise a camera; a device modeling component for modeling a device under test, the modeled device under test comprising the modeled characteristics of one or more sensors; an environment and motion modeling component for specifying a set of synthetic operating environments and motion profiles for the modeled device under test; a data generator component for generating a set of synthetic experiment data, the synthetic experiment data comprising synthetic sensor frames and reference frames based on the modeled device under test and set of synthetic operating environments and motion profiles; a post processor component for modeling execution of computer vision algorithms applied to the set of synthetic sensor frames; and an experiment manager component for iterating the generation of synthetic experiment data for differing parameters of the modeled device under test or differing synthetic operating environments and motion profiles.

Alternatively or in addition to the other examples described herein, some examples include any combination of the following: The one or more sensors may comprise a camera; modeling characteristics of one or more sensors may comprises modeling at least one selected from the list consisting of: shot noise, modulation transfer function (MTF), lens distortion, and quantum efficiency. The one or more sensors may comprise at least one selected from the list consisting of: a visible light sensor, a non-visible light sensor, a range sensor, a wireless receiver, an inertial measurement unit (IMU), and a sound receiver. Modeling a device under test may comprise modeling characteristics of two or more sensors and may comprise virtual calibration or dynamic runtime recalibration of the modeled device under test. The data generator may be implemented as a cloud-based service. A result analyzer or result analyzer component for analyzing the generated synthetic experiment data to enable identification of a desirable design configuration candidate.

### BRIEF DESCRIPTION OF THE DRAWINGS

The disclosed examples are described in detail below with reference to the accompanying drawing figures listed below:

FIG. 1 is a block diagram of an example computing environment suitable for implementing some of the various examples disclosed herein;

FIG. 2 is a block diagram of an example cloud-computing infrastructure suitable for a synthetics service implementing some of the various examples disclosed herein;

FIG. 3 is a block diagram of an example computing environment that may be implemented as a real-world device or synthesized using some of the various examples disclosed herein;

FIG. 4 is a block diagram of a computer vision sensor platform simulator suitable for implementing some of the various examples disclosed herein;

FIG. 5 is an illustration of an architecture for creating synthetic imagery, according to some of the various examples disclosed herein;

FIG. 6 is a block diagram of a synthetics pipeline suitable for implementing some of the various examples disclosed herein;

FIG. 7 is a block diagram of a process flow for modeling a computer vision platform, according to some of the various examples disclosed herein;

FIG. 8 is a flow chart illustrating an exemplary operation improving computer vision through simulated hardware optimization, suitable for implementing some of the various examples disclosed herein; and

FIG. 9 is an exemplary block diagram illustrating an operating environment for a computing device suitable for implementing various aspects of the disclosure.

Corresponding reference characters indicate corresponding parts throughout the drawings.

### DETAILED DESCRIPTION

The various embodiments will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

In general, designing solutions for both the hardware and algorithmic requirements for a new computer vision platform may be challenging. Computer vision applications typically require integrating a combination of carefully-selected sensors, sufficiently capable processors, and complex algorithms. The sensors include cameras and may also include other sensors, such as temperature, sound, wireless (e.g., WiFi, BLUETOOTH and GPS), and inertial measurement units (IMUs) that may further include three-dimensional (3D) accelerometers, gyroscopes and magnetometers. Processors may include general purpose CPUs or custom circuitry, such as perhaps dedicated processors, ASICs, or specially-programmed FPGAs. A wide range of complex algorithms may be involved, such as localization, object detection or recognition, rigidity, and scene reconstruction. Such algorithms may be highly sensitive to the precision and accuracy of the sensors, even as the platform may operate in a wide range of challenging environmental conditions.

Finding a suitable configuration sensor, computation, and algorithm choices may be a challenging and expensive process that involves specialists in multiple disciplines, such as mechanical engineering, electrical engineering, silicon design, computer vision, artificial intelligence (AI), robotics, and data capturing teams. Design teams may attempt to optimize solution design based on power, weight, thermal, and accuracy goals, while simultaneously attempting to support a widest range of environments and scenarios.

Thus, the process for designing a computer vision platform may require the specialists to iterate through employing a series of disparate modeling and development tools along with building prototype devices, testing the prototypes, and then cycling back to update the modeling and development efforts. These efforts would also need to iterate with an algorithm development team, possibly extending the design effort into a duration of months.

Systems and methods are disclosed for using a synthetic world interface to model environments, sensors, and platforms, such as for computer vision sensor platform design. Digital models may be passed through a simulation service to generate synthetic experiment data. Systematic sweeps of parameters for various components of the sensor or platform design under test, under multiple environmental conditions, can facilitate time- and cost-efficient engineering efforts by revealing parameter sensitivities and environmental effects for multiple proposed configurations. Searches through the generated synthetic experimental data results can permit rapid identification of desirable design configuration candidates.

A synthetics operation creates a virtual representation of the various components of a computer vision platform and then iterates on a parameter sweep to enable comparison of various candidate hardware configurations and algorithms prior to design finalization. Various design questions may be addressed, such as: (1) whether the camera has the proper lens, resolution, light sensitivity, dynamic range, and noise characteristics; (2) whether manufacturing tolerances will permit reliable algorithm function, (3) whether the physical layout (such as camera pointing direction) affects performance, such as whether the captured imagery is sufficient input for the algorithms to perform properly. A myriad of other design questions may also be addressed.

The synthetic solution provides advantages over a manual build-and-test development cycle, such as the avoidance of some expensive prototyping, developing platforms from tested hardware specifications, and sweeping parameters to obtain higher confidence in the optimality of the selected design solution. Users can generate synthetic test data to ascertain how well a specified architecture (hardware and algorithms) can perform, with reduced need for expensive and time-consuming prototyping, thereby improving computer vision through simulated hardware optimization.

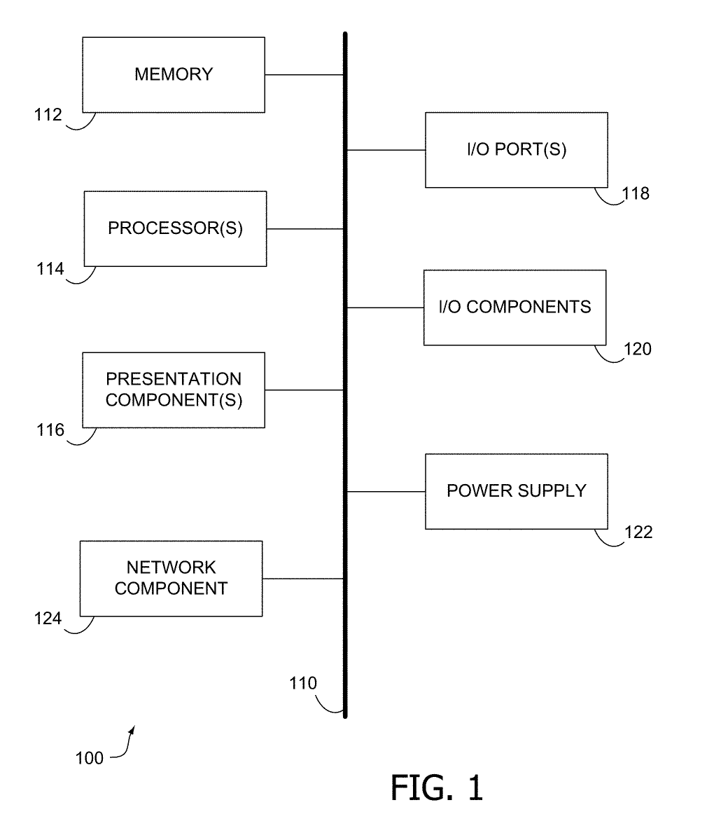

FIG. 1 is a block diagram of an example computing device 100 for implementing aspects disclosed herein, and is designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components/modules illustrated.

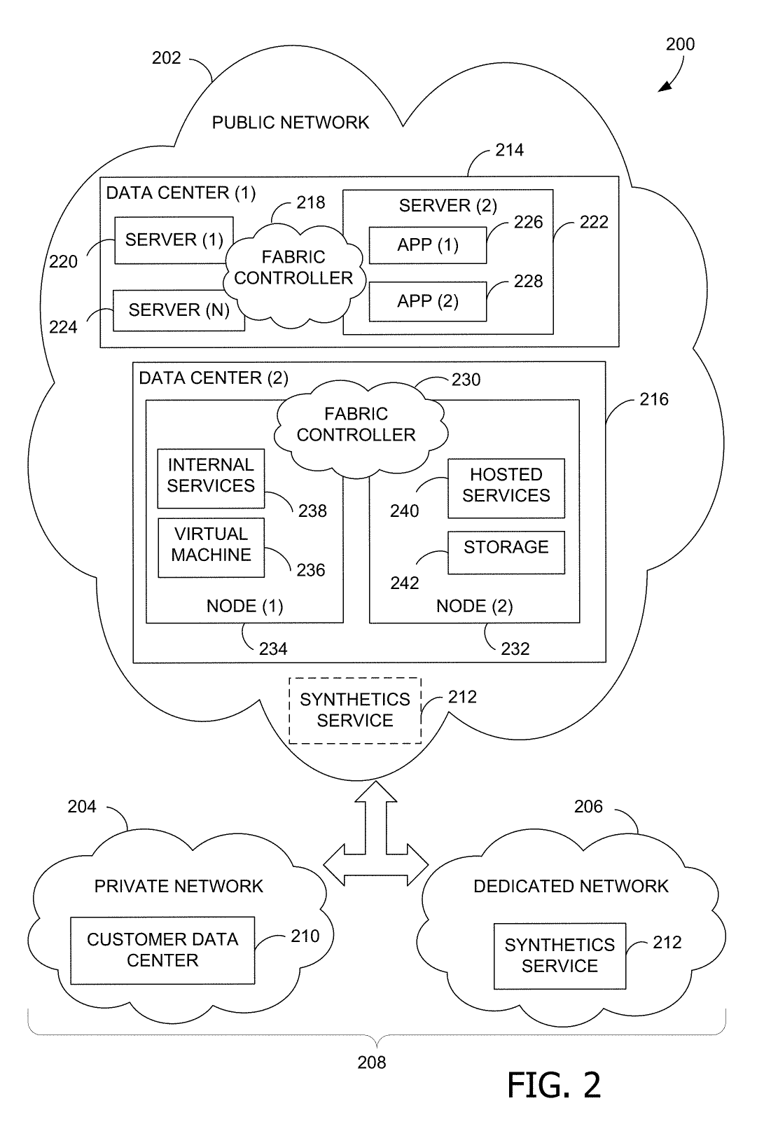

The examples and embodiments disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments, such as those disclosed in FIG. 2 described in more detail below, where tasks are performed by remote-processing devices that are linked through a communications network.

Computing device 100 includes a bus 110 that directly or indirectly couples the following devices: memory 112, one or more processors 114, one or more presentation components 116, input/output (I/O) ports 118, I/O components 120, a power supply 122, and a network component 124. Computing device 100 should not be interpreted as having any dependency or requirement related to any single component or combination of components illustrated therein. While computing device 100 is depicted as a seemingly single device, multiple computing devices 100 may work together and share the depicted device resources. For instance, memory 112 may be distributed across multiple devices, processor(s) 114 may provide housed on different devices, and so on.

Bus 110 represents what may be one or more busses (such as an address bus, data bus, or a combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and the references herein to a “computing device.”

Memory 112 may include any of the computer-readable media discussed below with reference to an “Exemplary Operating Environment.” Memory 112 may be used to store and access instructions configured to carry out the various operations disclosed herein. In some examples, memory 112 includes computer-storage media in the form of volatile and/or nonvolatile memory, removable or non-removable memory, data disks in virtual environments, or a combination thereof.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor, by multiple processors within the computing device 100, or by a processor external to the client computing device 100. In some examples, the processor(s) 114 are programmed to execute instructions such as those illustrated in the flowcharts discussed below and depicted in the accompanying drawings. Moreover, in some examples, the processor(s) 114 represent an implementation of analog techniques to perform the operations described herein. For example, the operations may be performed by an analog client computing device 100 and/or a digital client computing device 100.

Presentation component(s) 116 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways.

Ports 118 allow computing device 100 to be logically coupled to other devices including I/O components 120, some of which may be built in. Examples I/O components 120 include, for example but without limitation, a microphone, keyboard, mouse, joystick, game pad, satellite dish, scanner, printer, wireless device, etc.

In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, the network component 124 is operable to communicate data over public, private, or hybrid (public and private) using a transfer protocol, between devices wirelessly using short range communication technologies (e.g., near-field communication (NFC), BLUETOOTH® branded communications, or the like), or a combination thereof.

Turning now to FIG. 2, an exemplary block diagram illustrates a cloud-computing environment for improving computer vision through simulated hardware optimization. Architecture 200 illustrates an exemplary cloud-computing infrastructure, suitable for use in implementing aspects of this disclosure. Architecture 200 should not be interpreted as having any dependency or requirement related to any single component or combination of components illustrated therein. In addition, any number of nodes, virtual machines, data centers, role instances, or combinations thereof may be employed to achieve the desired functionality within the scope of embodiments of the present disclosure.

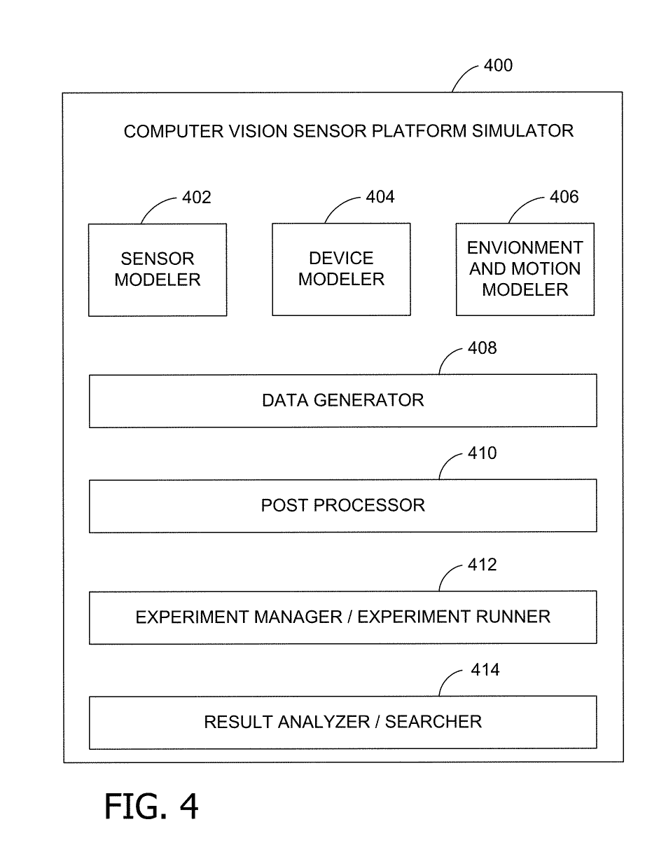

The distributed computing environment of FIG. 2 includes a public network 202, a private network 204, and a dedicated network 206. Public network 202 may be a public cloud-based network of computing resources, for example. Private network 204 may be a private enterprise network or private cloud-based network of computing resources. And dedicated network 206 may be a third-party network or dedicated cloud-based network of computing resources. In some examples, private network 204 may host a customer data center 210, and dedicated network 206 may host cloud synthetics services 212, which are discussed in more detail below relative to FIG. 4.

Hybrid cloud 208 may include any combination of public network 202, private network 204, and dedicated network 206. For example, dedicated network 206 may be optional, with hybrid cloud 208 comprised of public network 202 and private network 204. Along these lines, some customers may opt to only host a portion of their customer data center 210 in the public network 202 and/or dedicated network 206, retaining some of the customers' data or hosting of customer services in the private network 204. For example, a customer that manages healthcare data or stock brokerage accounts may elect or be required to maintain various controls over the dissemination of healthcare or account data stored in its data center or the applications processing such data (e.g., software for reading radiology scans, trading stocks, etc.). Myriad other scenarios exist whereby customers may desire or need to keep certain portions of data centers under the customers' own management. Thus, in some examples, customer data centers may use a hybrid cloud 208 in which some data storage and processing is performed in the public network 202 while other data storage and processing is performed in the dedicated network 206.

Public network 202 may include data centers configured to host and support operations, including tasks of a distributed application, according to the fabric controller 218. It will be understood and appreciated that data center 214 and data center 216 shown in FIG. 2 are merely examples of suitable implementations for accommodating one or more distributed applications, and are not intended to suggest any limitation as to the scope of use or functionality of examples disclosed herein. Neither should data center 214 and data center 216 be interpreted as having any dependency or requirement related to any single resource, combination of resources, combination of servers (e.g., servers 220 and 224) combination of nodes (e.g., nodes 232 and 234), or a set of application programming interfaces (APIs) to access the resources, servers, and/or nodes.

Data center 214 illustrates a data center comprising a plurality of servers, such as servers 220 and 224. A fabric controller 218 is responsible for automatically managing the servers 220 and 224 and distributing tasks and other resources within the data center 214. By way of example, the fabric controller 218 may rely on a service model (e.g., designed by a customer that owns the distributed application) to provide guidance on how, where, and when to configure server 222 and how, where, and when to place application 226 and application 228 thereon. One or more role instances of a distributed application, may be placed on one or more of the servers 220 and 224 of data center 214, where the one or more role instances may represent the portions of software, component programs, or instances of roles that participate in the distributed application. In other examples, one or more of the role instances may represent stored data that are accessible to the distributed application.

Data center 216 illustrates a data center comprising a plurality of nodes, such as node 232 and node 234. One or more virtual machines may run on nodes of data center 216, such as virtual machine 236 of node 234 for example. Although FIG. 2 depicts a single virtual node on a single node of data center 216, any number of virtual nodes may be implemented on any number of nodes of the data center in accordance with illustrative embodiments of the disclosure. Generally, virtual machine 236 is allocated to role instances of a distributed application, or service application, based on demands (e.g., amount of processing load) placed on the distributed application. As used herein, the phrase “virtual machine” is not meant to be limiting, and may refer to any software, application, operating system, or program that is executed by a processing unit to underlie the functionality of the role instances allocated thereto. Further, the virtual machine(s) 236 may include processing capacity, storage locations, and other assets within the data center 216 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 230 is responsible for automatically managing the virtual machines running on the nodes of data center 216 and for placing the role instances and other resources (e.g., software components) within the data center 216. By way of example, the fabric controller 230 may rely on a service model (e.g., designed by a customer that owns the service application) to provide guidance on how, where, and when to configure the virtual machines, such as virtual machine 236, and how, where, and when to place the role instances thereon.

As discussed above, the virtual machines may be dynamically established and configured within one or more nodes of a data center. As illustrated herein, node 232 and node 234 may be any form of computing devices, such as, for example, a personal computer, a desktop computer, a laptop computer, a mobile device, a consumer electronic device, a server, the computing device 100 of FIG. 1, and the like. In one instance, the nodes 232 and 234 host and support the operations of the virtual machine(s) 236, while simultaneously hosting other virtual machines carved out for supporting other tenants of the data center 216, such as internal services 238 and hosted services 240. Often, the role instances may include endpoints of distinct service applications owned by different customers.

Typically, each of the nodes include, or is linked to, some form of a computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role of instances that reside on the nodes may be to support operation of service applications, and thus they may be interconnected via APIs. In one instance, one or more of these interconnections may be established via a network cloud, such as public network 202. The network cloud serves to interconnect resources, such as the role instances, which may be distributed across various physical hosts, such as nodes 232 and 234. In addition, the network cloud facilitates communication over channels connecting the role instances of the service applications running in the data center 216. By way of example, the network cloud may include, without limitation, one or more communication networks, such as local area networks (LANs) and/or wide area networks (WANs). Such communication networks are commonplace in offices, enterprise-wide computer networks, intranets, and the Internet, and therefore need not be discussed at length herein.

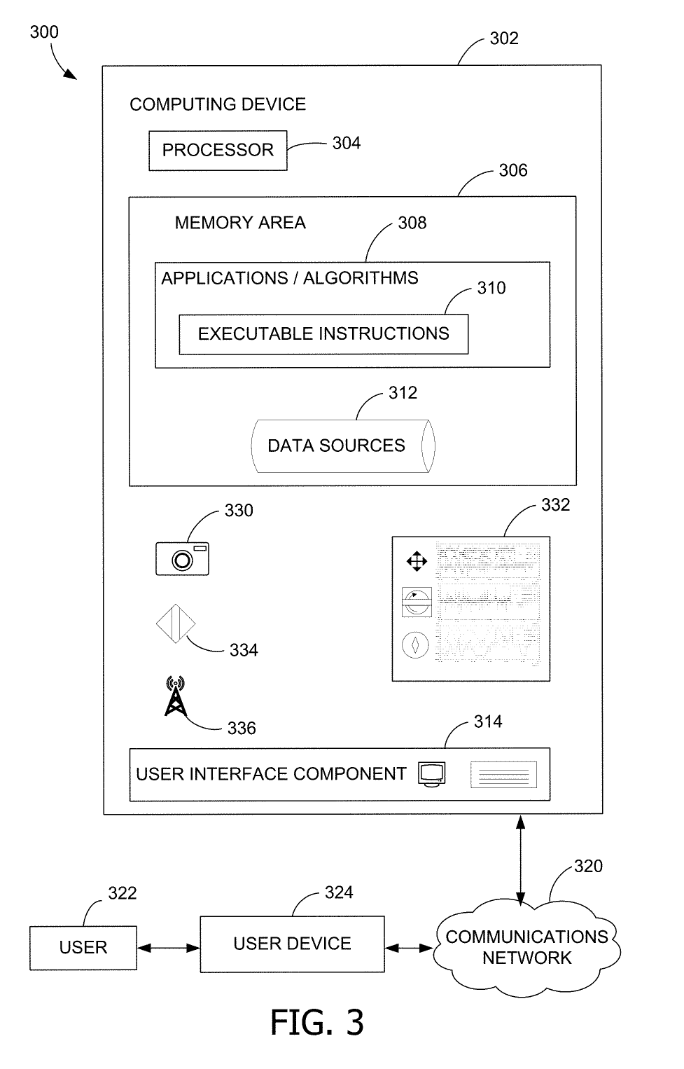

FIG. 3 is a block diagram of an example computing environment 300 that may be implemented as a real-world device or synthesized using some of the various examples disclosed herein. Computing device 302 represents any device executing instructions (e.g., as application programs, operating system functionality, or both) to implement operations and functionality as described herein. Computing device 302 may include a mobile computing device or any other portable device. In some examples, a mobile computing device includes a mobile telephone, laptop, tablet, computing pad, netbook, gaming device, wearable device, head mounted display (HMD) and/or portable media player. Computing device 302 may also represent less portable devices such as desktop personal computers, kiosks, tabletop devices, industrial control devices, wireless charging stations, electric automobile charging stations, and other physical objects embedded with computing resources and/or network connectivity capabilities. Additionally, computing device 302 may represent a group of processing units or other computing devices.

In some examples, computing device 302 has at least one processor 304, a memory area 306, and at least one user interface. These may be the same or similar to processor(s) 114 and memory 112 of FIG. 1, respectively. Processor 304 includes any quantity of processing units, and is programmed to execute computer-executable instructions for implementing aspects of the disclosure. The instructions may be performed by the processor or by multiple processors within the computing device, or performed by a processor external to the computing device. In some examples, processor 304 is programmed to execute instructions such as those that may be illustrated in the others figures.

In some examples, processor 304 represents an implementation of analog techniques to perform the operations described herein. For example, the operations may be performed by an analog computing device and/or a digital computing device.

Computing device 302 further has one or more computer readable media such as the memory area 306. Memory area 306 includes any quantity of media associated with or accessible by the computing device. Memory area 306 may be internal to computing device 302 (as shown in FIG. 3), external to the computing device (not shown), or both (not shown). In some examples, memory area 306 includes read-only memory and/or memory wired into an analog computing device.

Memory area 306 stores, among other data, one or more applications or algorithms 308 that include both data and executable instructions 310. The applications, when executed by the processor, operate to perform functionality on the computing device. Exemplary applications include localization applications having localization algorithms for identifying the coordinates of computing device 302. The applications may communicate with counterpart applications or services such as web services accessible via a network, such as communications network 320. For example, the applications may represent downloaded client-side applications that correspond to server-side services executing in a cloud. In some examples, applications generated may be configured to communicate with data sources and other computing resources in a cloud during runtime, or may share and/or aggregate data between client-side services and cloud services. Memory area 306 may store data sources 312, which may represent data stored locally at memory area 306, data access points stored locally at memory area 306 and associated with data stored remote from computing device 302, or any combination of local and remote data.

The user interface component 314, may include instructions executed by processor 304 of computing device 302, and cause the processor 304 to perform operations, including to receive user selection. Portions of user interface component 314 may thus reside within memory area 306. In some examples, user interface component 314 includes a graphics card for displaying data to a user 322 and receiving data from user 322. User interface component 314 may also include computer-executable instructions (e.g., a driver) for operating the graphics card. Further, user interface component 314 may include a display (e.g., a touch screen display or natural user interface) and/or computer-executable instructions (e.g., a driver) for operating the display. In some examples, the display may be a 3D display, such as may be found in an HMD. User interface component 314 may also include one or more of the following to provide data to the user or receive data from the user: a keyboard (physical or touchscreen display), speakers, a sound card, a camera, a microphone, a vibration motor, one or more accelerometers, a BLUETOOTH® brand communication module, global positioning system (GPS) hardware, and a photoreceptive light sensor. For example, the user may input commands or manipulate data by moving the computing device in a particular way. In another example, the user may input commands or manipulate data by providing a gesture detectable by the user interface component, such as a touch or tap of a touch screen display or natural user interface. In still other examples, a user, such as user 322, may interact with a separate user device 324, which may control or be controlled by computing device 302 over communications network 320, a wireless connection, or a wired connection.

As illustrated, computing device 302 further includes a camera 330, which may represent a single camera, a stereo camera set, a set of differently-facing cameras, or another configuration. Computing device 302 may also further include an inertial measurement unit (IMU) 332 that may incorporate one or more of an accelerometer, a gyroscope, and/or a magnetometer. The accelerometer gyroscope, and/or a magnetometer may each output measurements in 3D. The combination of 3D position and 3D rotation may be referred to as six degrees-of-freedom (6 DoF), and a combination of 3D accelerometer and 3D gyroscope data may permit 6 DoF measurements. In general, linear accelerometer data may be the most accurate of the data from a typical IMU, whereas magnetometer data may be the least accurate.

Also illustrated, computing device 302 additionally may include a generic sensor 334 and a radio system 336. Generic sensor 334 may include an infrared (IR) sensor (non-visible light sensor), a visible light sensor (such as an ambient light sensor or a spectrally-differentiated set of ambient light sensors), a light detection and ranging (LIDAR) sensor (range sensor), an RGB-D sensor (light and range sensor), an ultrasonic sensor, or any other sensor, including sensors associated with position-finding and range-finding. Radio system 336 may include BLUETOOTH®, WiFi, cellular, or any other radio or wireless system. Radio system 336 may act as a sensor by detecting signal strength, direction-of-arrival and location-related identification data in received signals, such as GPS signals. Together, one or more of camera 330, IMU 332, generic sensor 334, and radio system 336 may collect data (either real-world, or synthetics may virtually collect) for use in localization algorithms.

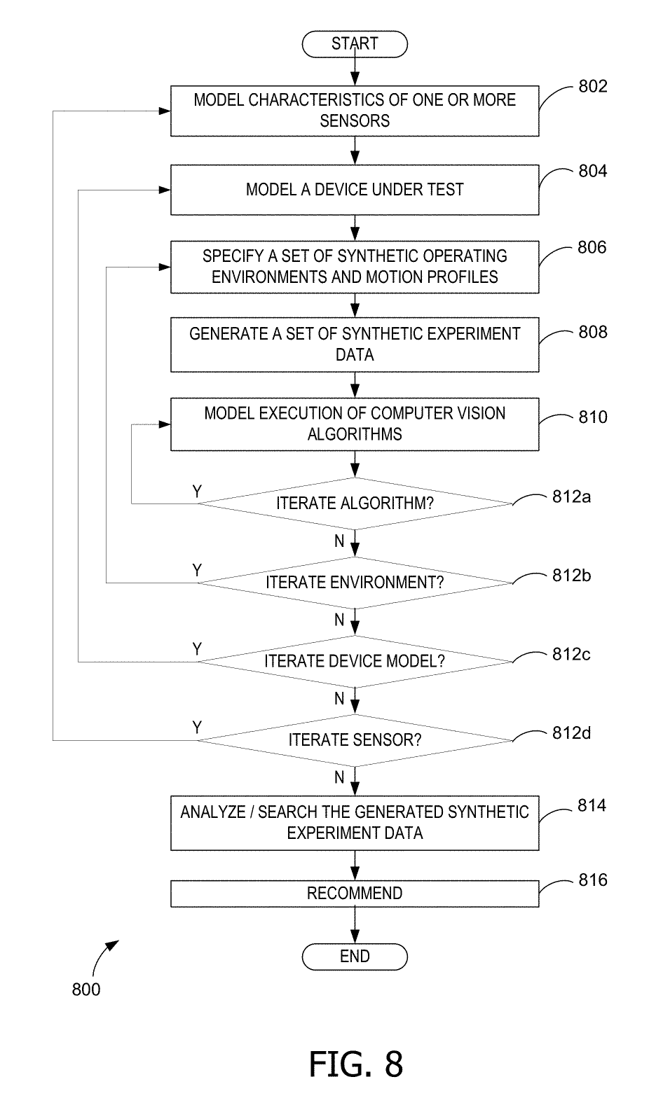

FIG. 4 is a block diagram of a computer vision sensor platform simulator 400 that is suitable for implementing some of the various examples disclosed herein. Computer vision sensor platform simulator 400 (CV simulator 400) may be implemented as a cloud service, in part or in whole, and may further be implemented on one or more computer storage devices having computer-executable instructions stored thereon for improving computer vision through simulated hardware optimization. That is, CV simulator 400 may leverage computing environments described in relation to other figures described herein. An exemplary operation of CV simulator 400 is illustrated in FIG. 8. It should be understood that functionality may be allocated among the different portions in some embodiments differently than is described in this exemplary embodiment.

CV simulator 400 includes a sensor modeler 402 for modeling characteristics of one or more sensors; a device modeler 404 for modeling a device under test, wherein the modeled device under test includes the modeled characteristics of the one or more sensors; an environment and motion modeler 406 for specifying a set of synthetic operating environments and motion profiles for the modeled device under test; a data generator 408 for generating a set of synthetic experiment data, the synthetic experiment data comprising synthetic sensor frames and reference frames based on the modeled device under test and set of synthetic operating environments and motion profiles; a post processor 410 for modeling execution of computer vision algorithms applied to the set of synthetic sensor frames; an experiment manager/experiment runner 412 for iterating the generation of synthetic experiment data for differing parameters of the modeled device under test or differing synthetic operating environments and motion profiles; and a result analyzer/searcher 414 for analyzing the generated synthetic experiment data to enable identification of a desirable design configuration candidate.

In some embodiments, sensor modeler 402 models characteristics of multiple sensors, including cameras, electromagnetic sensors (including visible light sensors, non-visible light sensors, and wireless receivers), IMUs, sound receivers, and other range or position sensors. The modeled camera characteristics may include shot noise, modulation transfer function (MTF), lens distortion, and/or quantum efficiency. Modeling of wireless receivers may include modeling of WiFi reception, including jitter, fading, and direction-of-arrival (DoA). Modeling of wireless receivers may include modeling GPS reception, decoding, and location, including location solution errors and ambiguities. Modeling of sound receivers may include modeling of acoustic ranging and detection units. Sensor modeler 402 may support parametric modeling of a wide range of base sensor components. The data for modeling may be in a library of pre-built components, or may be specified by a user.

In some embodiments, device modeler 404 permits users to combine two or more sensor models into a model of a device under test, possibly with support for virtual calibration and dynamic runtime recalibration of the modeled device under test. In this way, device modeler 404 creates a synthetic (virtual) device with synthetic sensors, such as a synthetic version of computing device 302 of FIG. 3. The modeling of synthetic device may include positioning the synthetic sensors on a virtual body that may have some flexibility characteristics modeled. For example, a virtual spatial tracking device may integrate a number of visible light cameras and a combination of other motion modeling sensors. Device modeler 404 enables users to provide an initial configuration of multiple candidate devices having different sensor sets, sensor characteristics, and sensor positioning and orientation. This permits a user to explore the performance of various design options and environmental conditions (such as lighting and motion) with a single set of experiments, thereby enabling rapid identification of a desirable design configuration candidate.

In some embodiments, device modeler 404 permits users to specify a target set of synthetic operating environments and motion profiles for the modeled device under test based on a library of environments and motion profiles or importing new environments. Simulated environments may include rooms with objects and outdoor areas. Simulated motion may include smooth motion at various speeds and erratic motion, such as shaking or vibration.

Environments and motions may be fully synthetically generated or may be imported from real-world images, recordings, and measurements.

In some embodiments, data generator 408 takes inputs from sensor modeler 402, device modeler 404, and environment and motion modeler 406 to generate synthetic experiment data sets. The synthetic experiment data sets may including sensor frames, such as synthetic imagery from the modeled camera or cameras, and synthetic sensor data, such as modeled IMU data, and also reference frames that are based on the sensor model, device model, environments and motions and perhaps other user input.

An integration framework can simulate execution of a model of various computer vision algorithms on various modeled processors, such as general purpose CPUs or custom circuitry, such as perhaps dedicated processors, ASICs, or specially-programmed FPGAs, taking the synthetic imagery and sensor data as inputs. Speed, precision, accuracy, and other results may be obtained by this simulation over the potentially wide range of modeled environments and motions. In some embodiments this portion of the simulation may occur within data generator 408, whereas in some embodiments, this portion of the simulation may occur within post processor 410. Post processor 410 enables users to create an arbitrary data package, store, and analyze data in various ways, thereby integrating the virtual testing of silicon and algorithms along with evaluation of the results.

Experiment manager 412 permits a user to specify which sensor or device parameters are to be varied for differing candidate hardware configuration, along with the set of environments and motions to be used. In some embodiments, result analyzer 414 compares results of algorithms performed on synthetic images with data extracted from the reference frames for example, camera pointing data. In some embodiments, result analyzer 414 may make a recommendation of a desirable candidate, whereas in some other embodiments, synthetic experiment data is output for human analysis and decision-making. In some embodiments, a result analysis may reduce to a relatively simple search problem for relatively optimal results.

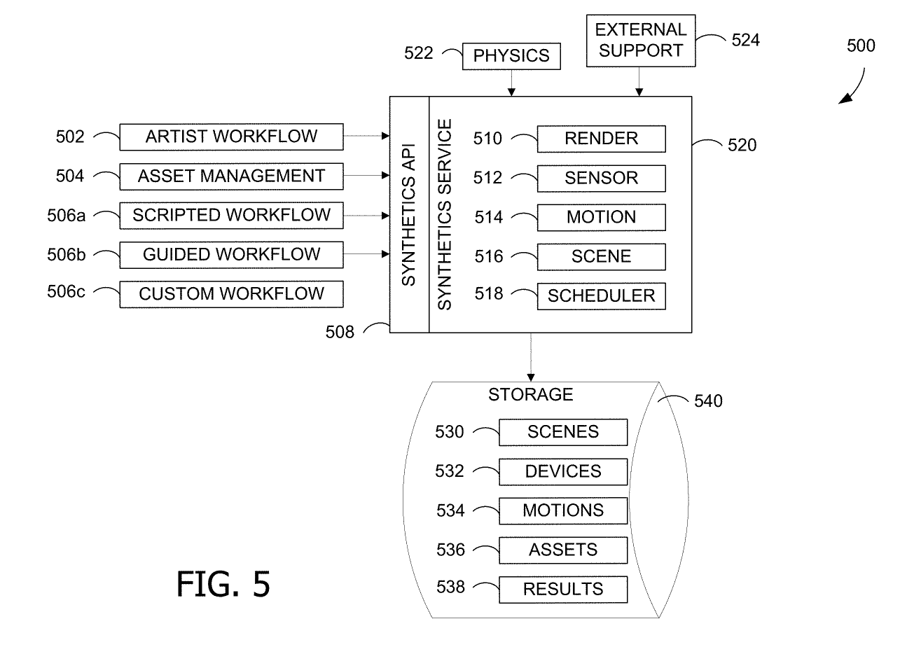

FIG. 5 is an illustration of an architecture 500 for creating synthetic imagery, according to some of the various examples disclosed herein. In architecture 500, several inputs, including an artist workflow 502, an asset management 504, and other workflows (a scripted workflow 506a, a guided workflow 506b, and a custom workflow 506c) interface via a synthetics API 508 to a synthetics service 520. Synthetics service 520 has multiple components or modules, including a renderer 510, a sensor modeler 512, a motion module 514, a scene generation module 516, and a scheduler 518. External functionality is illustrated as a physics service 522 and other external support 524, which may include off-loaded rendering computations. It should be understood that different functionalities may be internal or external services, and that FIG. 5 is only used for illustrative purposes. Together the various functionality is able to intake virtual objects (assets), lighting models, orchestrated motion, camera and other sensor positions, to render synthetic (virtual) scene imagery.

The generated synthetic imagery, scene data and other associated data may then be archived in a storage medium 540 for use in the described virtual experimentation. As illustrated, various data sets are stored, including the scene data 530, device data 532, motion data 534, asset data 536, and results 538.

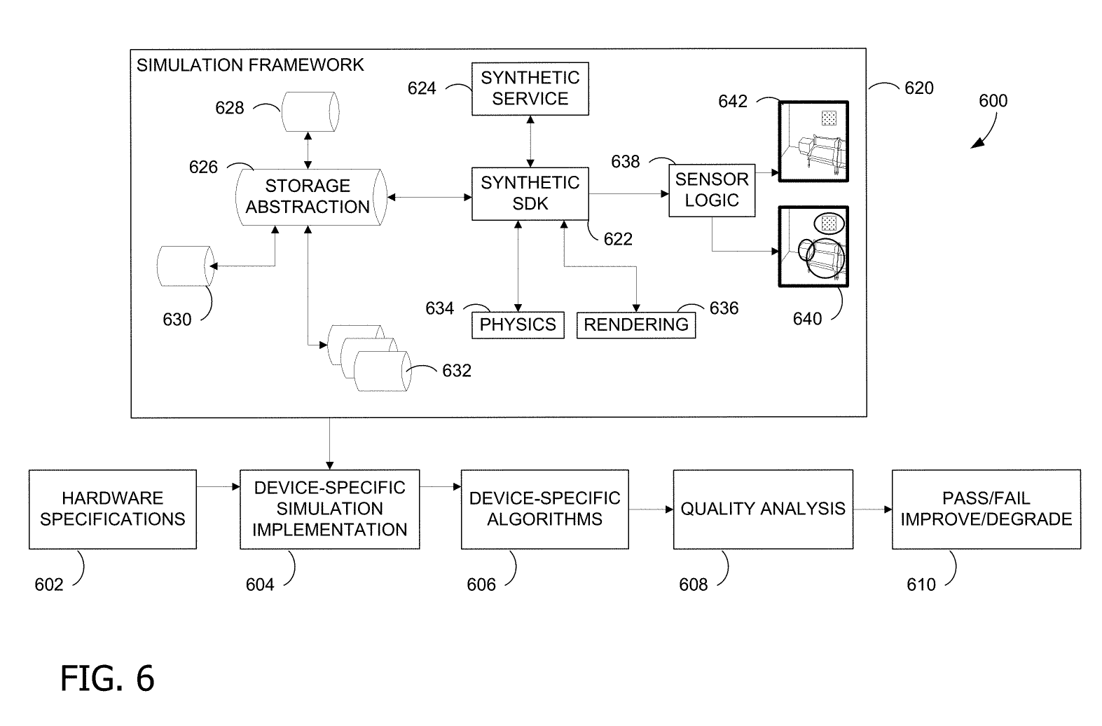

FIG. 6 is a block diagram of a synthetics pipeline 600 suitable for implementing some of the various examples disclosed herein, to simulate performance of sensor platforms under various conditions. Pipeline 600 includes importation 602 of hardware specifications, such as perhaps design candidates being considered by a manufacturer; a device-specific simulation implementation 604 that intakes models of the hardware as specified; a set of device-specific algorithms and their modeled execution 606; and a quality analysis 608 that quantifies predicted performance parameters, such as algorithm accuracy. A pass/fail or improve/degrade output 610 permits users to ascertain whether a candidate configuration passed or failed some threshold performance criteria, or whether a particular alteration in the specified candidate hardware or algorithm resulted in an improvement or degradation, relative to a baseline.

Simulation framework 620 includes further details for implementation of the simulation. A synthetics software development kit (SDK) 622 permits generation of model data and capabilities, and connects to a synthetics service 624. Relevant data can be retrieved and saved to a storage abstraction 626, which may have local and/or cloud components. Storage abstraction 626 is a notional interface to a data repository 628, that may be provided by the synthetics service provider, the user's own data repository 630, that may contain proprietary sensor models, and a third-party data repository 632. Synthetics SDK 622 leverages a physics service 634, that may provide high-quality modeling for physical phenomenon, and a rendering service 636 that may perform heavy computations for generating synthetic imagery. Synthetics SDK 622 further interfaces with a sensor logic module 638 outputs a dataset including the synthetic sensor data 642 and corresponding reference data 640 (ground truth). The circled objects in the illustration of reference data 640 indicate known objects within the reference data, in this case a chair, a table, and a picture on the wall. Having high confidence datasets allow the service to run the device runtime (using synthetic sensor data 642) and compare the results against reference data 640, producing predictions of the device's performance. For example, a device that is recognizing objects with a video camera, can experiment on different synthetic sensors 642 and compare the recognition results with reference data 640.

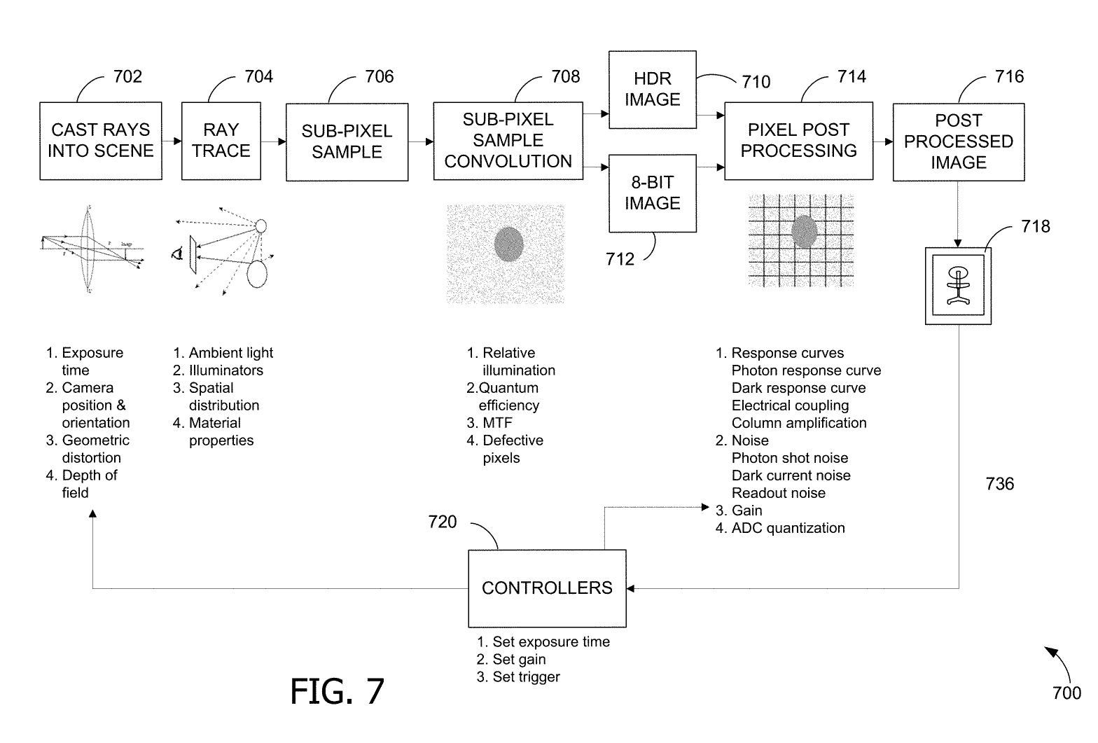

FIG. 7 is a block diagram of a process flow 700 for modeling a computer vision platform, according to some of the various examples disclosed herein. Ray tracing is commonly used in camera modeling. In process 702, rays are cast into the synthetic scene. As indicated, the simulation may involve multiple factors, such as light sensor exposure time, the position and orientation of the camera, and lens factors, such as geometric distortion and depth of field. Other lens effects, such as lens shadowing may also be modeled.

Ray tracing 704 is performed among the virtual objects within the synthetic scene, and include factors such as ambient lighting levels, illuminators (such as light sources), spatial distribution of various objects, and material properties of those objects that can affect reflections of the rays. A sub-pixel sampling 706 and convolution 708 are performed on a rasterization to model characteristics such as relative illumination of the pixels, quantum efficiency of the light collection wells, failures, and defective pixels (commonly caused by imperfections in the manufacture of the light sensors.) Thus, high-fidelity modeling of light sensor physical characteristics is possible.

In some embodiments, different image qualities may be output, including a high-dynamic-range (HDR) image 710 and an 8-bit-per-pixel image 712 that is more common in some computing architectures. Post processing 714 models response curves, such as a photon response curve, a dark response curve, electrical coupling, column amplification, and noise, such as photon shot noise, dark current shot noise, and readout noise. Gain and analog-to-digital (ADC) quantization are also modeled. The post processed image 716, as illustrated by an image 718 of an office chair is output. A controller 720 can set exposure time (an input to process 702) and gain (an input to process 714), along with triggering the synthetic camera.

FIG. 8 is a flow chart 800 illustrating an exemplary operation improving computer vision through simulated hardware optimization, suitable for implementing some of the various examples disclosed herein. Process 800 may be implemented as a cloud service, in part or in whole, and may further be implemented on one or more computer storage devices having computer-executable instructions stored thereon for improving computer vision through simulated hardware optimization. An exemplary CV simulator 400, as illustrated in FIG. 4 may operate according to flow chart 800. It should be understood that functionality may be allocated in some embodiments in a different order differently than is described in this exemplary embodiment.

Process 800 starts with modeling characteristics of one or more sensors at operation 802 that may comprise one or more cameras. Modeling characteristics of one or more cameras comprises modeling at least one selected from the list consisting of: shot noise, MTF, lens distortion, and quantum efficiency. Modeling characteristics of one or more sensors may also comprise modeling at least one selected from the list consisting of: a visible light sensor, a non-visible light sensor, a range sensor, a wireless receiver, an IMU, and a sound receiver.

The process then proceeds to modeling a device under test at operation 804, which may optionally comprise modeling characteristics of two or more sensors and modeling virtual calibration or dynamic runtime recalibration of the modeled device under test. A user or automated process may specify a set of synthetic operating environments and motion profiles at operation 806 for the modeled device under test. A user may specify a set of default environment conditions and motion profiles, such as typical us or extreme conditions, in order to render a desired number of test frames for analysis. For example, users may specify a statistically representative set of environments and motions that will enable them to robustly explore their designs.

The process then proceeds to generating a set of synthetic experiment data at operation 808, in which the synthetic experiment data comprising synthetic sensor frames and reference frames based on the modeled device under test and set of synthetic operating environments and motion profiles. With the synthetic experiment data available, the process proceeds to modeling execution of computer vision algorithms at operation 810 that are applied to the set of synthetic sensor frames. In some embodiments, operations 808 and 810 together may be collectively referred to as generating the synthetic experiment data.

Various aspects of process 800 may be iterated by an experiment manager, such as iterating among different algorithms at operation 812a, iterating among different environments at operation 812b, iterating among different device models at operation 812c, and iterating among different sensors at operation 812d. Collectively, iteration decisions 812a-812d iterate the generation of synthetic experiment data for differing parameters of the modeled device under test or differing synthetic operating environments and motion profiles. As illustrated, there may be 16 different possible iteration scenarios (2\hat{ }4) for generating the synthetic experiment data. Although the iteration controls 812a-812d are illustrated in a given order, it should be understood that the illustration is merely exemplary of a possible embodiment, and the iteration may occur in any order or combination.

The process proceeds to analyze/search the generated synthetic experiment data at operation 814 to enable identification of a desirable design configuration candidate. In some embodiments, a result analysis may reduce to a relatively simple search problem for relatively optimal results. Simulated execution and evaluation of an algorithm under test may be integrated with a post-processor. A user may then analyze data, iterate on parameters of candidate devices, and repeat, performing systematic sweeps of various components of the sensor design under test. With the specified synthetic experiment data available, results may be presented to a user in recommend operation 816, either as a selected configuration or as output of a larger set of results from which a separate selection process may be performed. Recommend operation 816 may include post-processing operations to identify a desirable configuration, or perhaps a search for relative performance optima, or perhaps may be a simpler pass/fail or improve/degrade indication.

Tables 1-3 show Matlab output for an example real-world application of process 800. A design team considered different configurations for a dual-camera mixed reality (MR) device. The query was focused on whether a particular design, within some parameters, would operate. One of the design considerations was selecting the vertical and horizontal pointing directions. Several hundred test cases were run, with on the order of a dozen trials each for probabilistic noise modeling. Using Tables 1-3, it can be seen that a proposed design with cameras pointing angles of DOWN=−5, and OUT=30 produced a 5.41 milliradian pointing error with a 1.34 milliradian jitter and a predicted 100% reliability.

TABLE 1
Median Angular Error [mrad]

| | Down−> | | | | | |
|---|---|---|---|---|---|---|
| Out | 11 | 5 | 0 | −5 | −11 | −16 |
| 50 | 15.15 | 16.2 | 11.47 | 11.7 | 11.33 | 12.02 |
| 45 | 12.77 | 13.57 | 10.98 | 10.43 | 10.54 | 11.2 |
| 40 | 12.21 | 9.6 | 9.09 | 9.74 | 9.43 | 9.88 |
| 35 | 9.39 | 7.92 | 7.15 | 7.08 | 6.91 | 6.79 |
| 30 | 6.41 | 6.1 | 5.74 | 5.41 | 5.81 | 5.8 |
| 25 | 5.98 | 5.88 | 5.79 | 6.17 | 6.1 | 6.21 |
| 20 | 6.33 | 7.35 | 6.8 | 6.58 | 6.42 | 6.39 |
| 15 | 7.15 | 6.83 | 6.73 | 7.15 | 7.06 | 7.06 |
| 10 | 8.24 | 8.1 | 7.32 | 7.86 | 7.68 | 7.29 |
| 5 | 9.91 | 8.51 | 9.3 | 8.69 | 9.05 | 9.09 |
| 0 | 8.83 | 10.52 | 9.61 | 9.79 | 9.25 | 9.47 |
| EV4: | | | 2.77 | | | |

TABLE 2
Median Jitter [mrad]

| | Down−> | | | | | |
|---|---|---|---|---|---|---|
| Out | 11 | 5 | 0 | −5 | −11 | −16 |
| 50 | 3.39 | 3.36 | 2.63 | 2.7 | 2.74 | 2.83 |
| 45 | 2.85 | 2.46 | 2.26 | 2.1 | 2.19 | 2.03 |
| 40 | 2.53 | 1.85 | 1.88 | 1.91 | 1.8 | 1.88 |
| 35 | 2 | 1.61 | 1.53 | 1.46 | 1.57 | 1.55 |
| 30 | 1.55 | 1.45 | 1.39 | 1.34 | 1.37 | 1.36 |
| 25 | 1.58 | 1.33 | 1.44 | 1.45 | 1.41 | 1.43 |
| 20 | 1.56 | 1.7 | 1.5 | 1.43 | 1.43 | 1.43 |
| 15 | 1.62 | 1.54 | 1.53 | 1.6 | 1.68 | 1.56 |
| 10 | 1.92 | 1.82 | 1.63 | 1.63 | 1.69 | 1.6 |
| 5 | 2.19 | 1.91 | 2.05 | 1.8 | 2.03 | 1.92 |
| 0 | 2.15 | 2.56 | 2.24 | 2.2 | 2.25 | 2.23 |
| EV4: | | | 0.62 | | | |

TABLE 3
Mean Reliability [%]

| | Down−> | | | | | |
|---|---|---|---|---|---|---|
| Out | 11 | 5 | 0 | −5 | −11 | −16 |
| 50 | 95.47 | 96.05 | 97.05 | 97.64 | 97.81 | 97.33 |
| 45 | 99.52 | 99.49 | 99.1 | 99.69 | 99.66 | 99.42 |
| 40 | 99.21 | 99.39 | 99.86 | 99.83 | 99.92 | 99.9 |
| 35 | 100 | 99.88 | 100 | 99.93 | 99.94 | 100 |
| 30 | 100 | 100 | 100 | 100 | 100 | 100 |
| 25 | 100 | 100 | 100 | 100 | 100 | 100 |
| 20 | 100 | 99.99 | 100 | 100 | 100 | 100 |
| 15 | 100 | 99.99 | 100 | 100 | 100 | 100 |
| 10 | 99.99 | 99.83 | 99.9 | 99.96 | 99.99 | 100 |
| 5 | 99.89 | 99.81 | 99.81 | 99.74 | 99.83 | 99.82 |
| 0 | 99.89 | 99.71 | 99.85 | 99.79 | 99.89 | 99.83 |
| EV4: | | | 99.79 | | | |

### Additional Examples

Some examples are directed to a system for simulating computer vision, the system comprising: a sensor modeler for modeling characteristics of one or more sensors; a device modeler for modeling a device under test, the modeled device under test comprising the modeled characteristics of one or more sensors; an environment and motion modeler for specifying a set of synthetic operating environments and motion profiles for the modeled device under test; a data generator for generating a set of synthetic experiment data, the synthetic experiment data comprising synthetic sensor frames and reference frames based on the modeled device under test and set of synthetic operating environments and motion profiles; a post processor for modeling execution of computer vision algorithms applied to the set of synthetic sensor frames; and an experiment manager for iterating the generation of synthetic experiment data for differing parameters of the modeled device under test or differing synthetic operating environments and motion profiles.

Some examples are directed to a method for simulating computer vision, the system comprising: modeling characteristics of one or more sensors; modeling a device under test, the modeled device under test comprising the modeled characteristics of one or more sensors; specifying a set of synthetic operating environments and motion profiles for the modeled device under test; generating a set of synthetic experiment data, the synthetic experiment data comprising synthetic sensor frames and reference frames based on the modeled device under test and set of synthetic operating environments and motion profiles; modeling execution of computer vision algorithms applied to the set of synthetic sensor frames; and iterating the generation of synthetic experiment data for differing parameters of the modeled device under test or differing synthetic operating environments and motion profiles.

Some examples are directed to one or more computer storage devices having computer-executable instructions stored thereon for computing a localization parameter, which, on execution by a computer, cause the computer to perform operations, the instructions comprising: a sensor modeling component for modeling characteristics of one or more sensors, wherein the one or more sensors comprise a camera; a device modeling component for modeling a device under test, the modeled device under test comprising the modeled characteristics of one or more sensors; an environment and motion modeling component for specifying a set of synthetic operating environments and motion profiles for the modeled device under test; a data generator component for generating a set of synthetic experiment data, the synthetic experiment data comprising synthetic sensor frames and reference frames based on the modeled device under test and set of synthetic operating environments and motion profiles; a post processor component for modeling execution of computer vision algorithms applied to the set of synthetic sensor frames; and an experiment manager component for iterating the generation of synthetic experiment data for differing parameters of the modeled device under test or differing synthetic operating environments and motion profiles.

Alternatively or in addition to the other examples described herein, some examples include any combination of the following: The one or more sensors may comprise a camera; modeling characteristics of one or more sensors may comprises modeling at least one selected from the list consisting of: shot noise, modulation transfer function (MTF), lens distortion, and quantum efficiency. The one or more sensors may comprise at least one selected from the list consisting of: a visible light sensor, a non-visible light sensor, a range sensor, a wireless receiver, an inertial measurement unit (IMU), and a sound receiver. Modeling a device under test may comprise modeling characteristics of two or more sensors and may comprise virtual calibration or dynamic runtime recalibration of the modeled device under test. The data generator may be implemented as a cloud-based service. A result analyzer or result analyzer component for analyzing the generated synthetic experiment data to enable identification of a desirable design configuration candidate.

Alternatively, or in addition to the other examples described herein, examples include any combination of the following:
wherein the one or more sensors comprise a camera;
wherein modeling characteristics of one or more sensors comprises modeling at least one selected from the list comprising: shot noise, modulation transfer function (MTF), lens distortion, relative illumination, dark current noise, and quantum efficiency;
wherein the one or more sensors comprise at least one selected from the list comprising: a visible light sensor, a non-visible light sensor, a range sensor, a wireless receiver, an inertial measurement unit (IMU), and a sound receiver;
wherein modeling a device under test comprises virtual calibration or dynamic runtime recalibration of the modeled device under test;
wherein modeling a device under test comprises modeling characteristics of two or more sensors;
wherein the data generator comprises a cloud-based service;
a result analyzer for analyzing the generated synthetic experiment data to enable identification of a desirable design configuration candidate;
wherein generating a set of synthetic experiment data comprises generating a set of synthetic experiment data as a cloud-based service;
analyzing the generated synthetic experiment data to enable identification of a desirable design configuration candidate.

While the aspects of the disclosure have been described in terms of various examples with their associated operations, a person skilled in the art would appreciate that a combination of operations from any number of different examples is also within scope of the aspects of the disclosure.

### Example Operating Environment

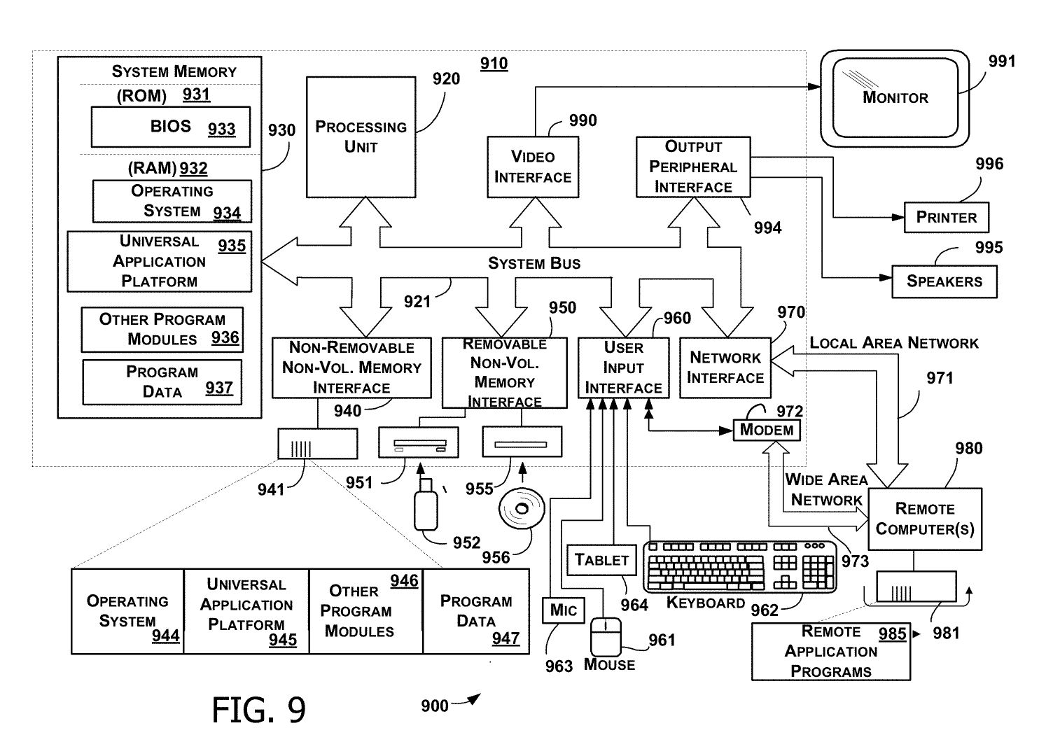

FIG. 9 illustrates an example of a suitable computing and networking environment 900 on which the examples of FIG. 1, FIG. 2, and FIG. 3 may be implemented. The computing environment 900 is only one example of a suitable computing environment and is not intended to suggest any limitation as to the scope of use or functionality of the disclosure. Neither should the computing environment 900 be interpreted as having any dependency or requirement relating to any one or combination of components illustrated in the exemplary operating environment 900.

The disclosure is operational with numerous other general purpose or special purpose computing environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 9, an exemplary architecture for implementing various aspects of the disclosure may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media may be any available media that may be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Memory 931 and 932 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 910. Computer storage media does not, however, include propagated signals. Rather, computer storage media excludes propagated signals. Any such computer storage media may be part of computer 910.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs, such as universal application platform 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a universal serial bus (USB) port 951 that provides for reads from or writes to a removable, nonvolatile memory 952, and an optical disk drive 955 that reads from or writes to a removable, nonvolatile optical disk 956 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and USB port 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, universal application platform 945, other program modules 946 and program data 947. Note that these components may either be the same as or different from operating system 934, universal application platform 935, other program modules 936, and program data 937. Operating system 944, universal application platform 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel may be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

Although described in connection with an example computing device 100, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The examples illustrated and described herein, as well as examples not specifically described herein but within the scope of aspects of the disclosure, constitute exemplary means for providing improving computer vision through simulated hardware optimization. For example, the elements described in FIGS. 4-7, such as when encoded to perform the operations illustrated in FIG. 8, constitute exemplary means for improving computer vision through simulated hardware optimization.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for simulating computer vision, the system comprising:
a sensor modeler for modeling characteristics of one or more sensors;
a device modeler for modeling a device under test, the modeled device under test comprising the modeled characteristics of one or more sensors;
an environment and motion modeler for specifying a set of synthetic operating environments and motion profiles for the modeled device under test;
a data generator for generating a set of synthetic experiment data, the synthetic experiment data comprising synthetic sensor frames and reference frames based on the modeled device under test and set of synthetic operating environments and motion profiles;
a post processor for modeling execution of computer vision algorithms applied to the set of synthetic sensor frames; and
an experiment manager for iterating the generation of synthetic experiment data for differing parameters of the modeled device under test or differing synthetic operating environments and motion profiles.

2. The system of claim 1 wherein the one or more sensors comprise a camera.

3. The system of claim 2 wherein modeling characteristics of one or more sensors comprises modeling at least one selected from the list comprising:
shot noise, modulation transfer function (MTF), lens distortion, relative illumination, dark current noise, and quantum efficiency.

4. The system of claim 1 wherein the one or more sensors comprise at least one selected from the list comprising:
a visible light sensor, a non-visible light sensor, a range sensor, a wireless receiver, an inertial measurement unit (IMU), and a sound receiver.

5. The system of claim 1 wherein modeling a device under test comprises virtual calibration or dynamic runtime recalibration of the modeled device under test.

6. The system of claim 1 wherein modeling a device under test comprises modeling characteristics of two or more sensors.

7. The system of claim 1 wherein the data generator comprises a cloud-based service.

8. The system of claim 1 further comprising:
a result analyzer for analyzing the generated synthetic experiment data to enable identification of a desirable design configuration candidate.

9. A method for simulating computer vision, the system comprising:
modeling characteristics of one or more sensors;
modeling a device under test, the modeled device under test comprising the modeled characteristics of one or more sensors;
specifying a set of synthetic operating environments and motion profiles for the modeled device under test;
generating a set of synthetic experiment data, the synthetic experiment data comprising synthetic sensor frames and reference frames based on the modeled device under test and set of synthetic operating environments and motion profiles;
modeling execution of computer vision algorithms applied to the set of synthetic sensor frames; and
iterating the generation of synthetic experiment data for differing parameters of the modeled device under test or differing synthetic operating environments and motion profiles.

10. The method of claim 9 wherein the one or more sensors comprise a camera.

11. The method of claim 10 wherein modeling characteristics of one or more sensors comprises modeling at least one selected from the list comprising:
shot noise, modulation transfer function (MTF), lens distortion, relative illumination, dark current noise, and quantum efficiency.

12. The method of claim 9 wherein the one or more sensors comprise at least one selected from the list comprising:
a visible light sensor, a non-visible light sensor, a range sensor, a wireless receiver, an inertial measurement unit (IMU), and a sound receiver.

13. The method of claim 9 wherein modeling a device under test comprises virtual calibration or dynamic runtime recalibration of the modeled device under test.

14. The method of claim 9 wherein modeling a device under test comprises modeling characteristics of two or more sensors;

15. The method of claim 9 wherein generating a set of synthetic experiment data comprises generating a set of synthetic experiment data as a cloud-based service.

16. The method of claim 9 further comprising:
analyzing the generated synthetic experiment data to enable identification of a desirable design configuration candidate.

17. One or more computer storage devices having computer-executable instructions stored thereon for simulating computer vision, which, on execution by a computer, cause the computer to perform operations, the instructions comprising:
a sensor modeling component for modeling characteristics of one or more sensors, wherein the one or more sensors comprise a camera;
a device modeling component for modeling a device under test, the modeled device under test comprising the modeled characteristics of one or more sensors;
an environment and motion modeling component for specifying a set of synthetic operating environments and motion profiles for the modeled device under test;
a data generator component for generating a set of synthetic experiment data, the synthetic experiment data comprising synthetic sensor frames and reference frames based on the modeled device under test and set of synthetic operating environments and motion profiles;
a post processor component for modeling execution of computer vision algorithms applied to the set of synthetic sensor frames; and
an experiment manager component for iterating the generation of synthetic experiment data for differing parameters of the modeled device under test or differing synthetic operating environments and motion profiles.

18. The one or more computer storage devices of claim 17 wherein modeling characteristics of one or more sensors comprises modeling at least one selected from the list comprising:
shot noise, modulation transfer function (MTF), lens distortion, relative illumination, dark current noise, and quantum efficiency.

19. The one or more computer storage devices of claim 17 wherein the one or more sensors additionally comprise at least one selected from the list comprising:
a visible light sensor, a non-visible light sensor, a range sensor, a wireless receiver, an inertial measurement unit (IMU), and a sound receiver.

20. The one or more computer storage devices of claim 17 wherein instructions further comprise:
a result analyzer component for analyzing the generated synthetic experiment data to enable identification of a desirable design configuration candidate.
